(19) United States
(12) Patent Application Publication
(10) Pub. No.: US 2005/0046696 A1
(43) Pub. Date: Mar. 3, 2005

(54) Vehicle camera and light in a common housing

(76) Inventors: Heinrich Lang, Ergersheim (DE); Peter Fleischer, Nurnberg (DE)

Correspondence Address: McNair Law Firm, P.A., P.O. Box 10827, Greenville, SC, 29603-0827, US

(21) Appl. No.: 10/926,667

(22) Filed: Aug. 26, 2004

(30) Foreign Application Priority Data
Aug. 28, 2003 (DE) 20313003.0
Dec. 13, 2003 (DE) 20319579.5

(51) Int. Cl. H04N 7/18

(52) U.S. Cl. 348/148

(57) ABSTRACT

A system for providing a driver with images of the area behind the vehicle, and providing lighting from the back of a vehicle indicating operations of the vehicle. The system contains a vehicle light housing for installation on the rear of a vehicle and a lighting element embodied within the housing. The lighting element provides lighting from the back of a vehicle to indicate actions such as braking. The system also contains a camera embodied within the housing for providing images of the area behind the vehicle. The system further contains power connectors for connecting the vehicle light housing to a power source for providing power to the lighting element and camera. The system further contains a video connector for transmitting the images obtained by the camera to the operator of the vehicle.

### BACKGROUND OF THE INVENTION

The present invention relates to a light, in particular a brake light with integrated camera for application in motor vehicles and in particular utility vehicles.

Camera installations are known from the state of the art, for instance as loading and docking aides to monitor the area around the vehicle which the driver cannot see directly. The publication open for public inspection DE 198 16 054 A1 describes a camera system to monitor the surroundings of a vehicle that cannot be seen directly. The cameras needed to monitor the surroundings are mounted on the back of the vehicle as well as at the level of the outside mirrors, in order to monitor so-called blind spots of a vehicle.

However, commercially available camera systems utilize cameras that are installed in the vehicle in addition to the elements visible from the outside such as tail lights, brake lights, third tail lights. The camera as an additional element that must be installed within the vehicle leads to higher costs, especially in designing the body of a vehicle as well as in construction, since the vehicle manufacturer must take into account an additional component, and thereby its placement within the overall vehicle package, i.e. for the integration of the individual parts into a complete vehicle.

Furthermore, cameras that must be added on the body must also be taken into account in planning the aerodynamics of a vehicle and must be protected from damage by suitable housings.

This disadvantage of additional assembly work is avoided by the state of the art according to DE 100 10 434 A1 from which a brake light with integrated camera is known. However the image quality of the image obtained by the camera can be affected adversely by the lighting up of the brake light because of the directly adjoining position of camera and stop light.

DE 39 00 667 A1 discloses a periscope-like camera arrangement for motor vehicles. The device extending from the roof of the motor vehicle comprises a camera with a predetermined direction of vision and a stop light in the opposite direction in one common housing.

DE 198 16 054 A1 discloses a camera system to monitor surroundings of a vehicle that are not directly visible. The system comprises several cameras installed all around the vehicle, among other locations in the rear area. One of these cameras can be integrated into a brake light. Thereby the brake light can overexpose the image recorded by the camera also in this case when it lights up.

Based on the closest state of the art it is the object of the present invention to create a light with integrated camera in which the lighting up of the light does not adversely affect the image quality of the camera.

Considering these disadvantages of the state of the art, it is the object of the present invention to create a light with integrated camera in which the lighting up of the light does not adversely affect the image quality of the camera.

### SUMMARY OF THE INVENTION

The above objectives are accomplished by providing a system for providing the driver of a vehicle with images of the area behind the vehicle, and providing lighting from the back of a vehicle indicating operations of the vehicle. The system contains a vehicle light housing for installation on the rear of a vehicle and a lighting element embodied within the vehicle light housing. The lighting element is for providing lighting from the back of a vehicle to indicate actions of the vehicle such as braking or placing the vehicle in reverse. The system also contains a camera for providing images of the area behind the vehicle to a user of the vehicle. The camera is embodied within the vehicle light housing. The system further contains power connectors embodied on the rear portion of the vehicle light housing for connecting said vehicle light housing to a power source for providing power to the lighting element and camera. The system further contains a video connector member embodied on the rear of the vehicle light housing for transmitting the images obtained by the camera to the operator of the vehicle. The system further contains a housing cover for protecting the lighting element protruding from the rear of the vehicle light housing and covering the lighting element.

The system my also vertically space the camera below the lighting element in order to allow the camera to obtain images that are not affected by the actuation of the lighting element. The system my also horizontally space the camera below the lighting element in order to allow the camera to obtain images that are not affected by the actuation of the lighting element. The system may also contain a shield for preventing the light emitted from the lighting element from entering the camera. Thus, the camera can provide images of the area behind the vehicle that are unaltered due to the actuation of the lighting element. The housing cover may also enclose the lighting element and the camera. The cover may be clear in an area through which the camera records for effective camera recording. The housing cover may also be a generally clear cover and the lighting element can emit a red light.

The camera may also be capable of swiveling, whereby images of the area behind the vehicle are provided to a user of the vehicle with a wider range. The camera may be mounted by means of a ball and socket joint, wherein the camera is capable of swiveling whereby images of the area behind the vehicle are provided to a user of the vehicle with a wider range. The system may also contain a convexly shaped lens on the camera for protecting image distortion due to any environmental elements collecting on the camera. The system may also contain a housing cover that is convex in at least the area in which the camera records through the housing cover whereby the camera obtains images unaffected by any accumulated environmental elements. The system of claim may contain a plurality of lighting elements. The camera may be surrounded by these lighting elements. The lighting elements may be LED's.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a side view of a truck with the camera and light in a common housing installed on the truck.

FIG. 2 is a side view illustrating a brake light with integrated camera.

FIG. 3 is a side view illustrating a brake light with integrated camera with a common housing cover.

FIG. 4 is a front view of FIG. 1 illustrating a brake light and camera in a common housing.

FIG. 5 is a front view illustrating a camera integrated in a common housing with a plurality of LED lighting elements.

### DETAILED DESCRIPTION OF A PREFERRED EMBODIMENT

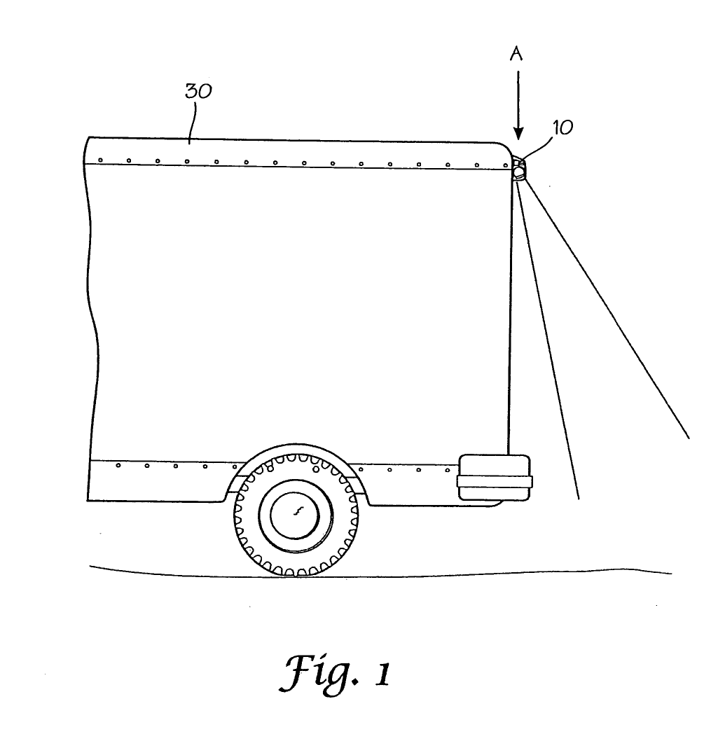

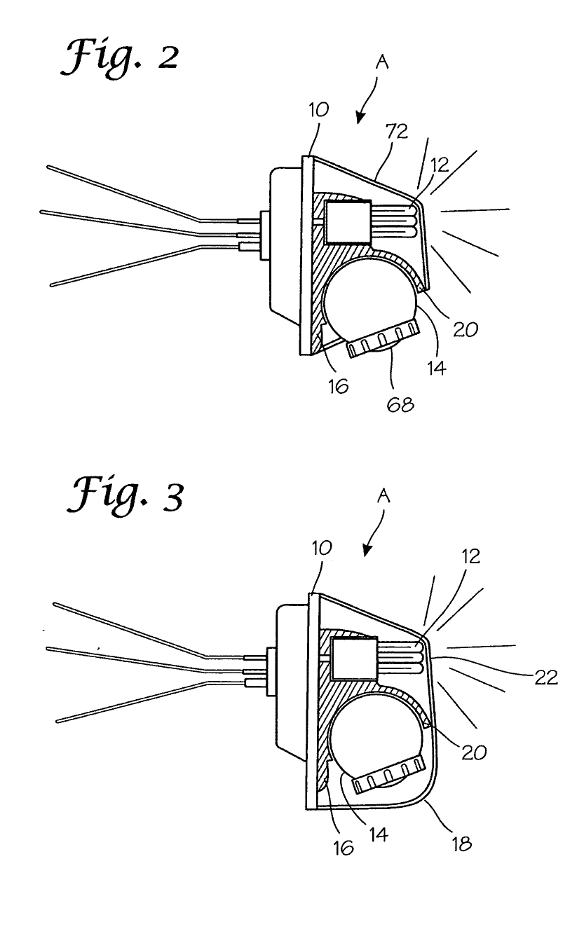

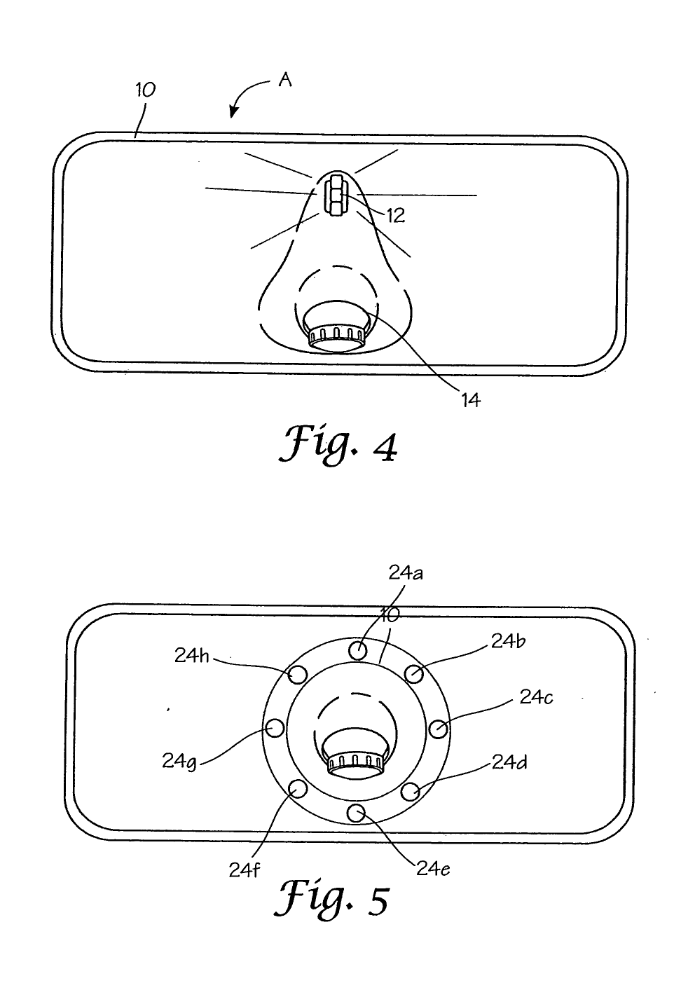

Referring now to the drawings, the invention will now be described in more detail. In FIG. 1, a light camera assembly, designated generally as A is illustrated as mounted to the rear end of a truck vehicle. As can best be seen in the two embodiments of FIGS. 2 and 3, assembly A includes a camera 14 mounted in a camera holder 16 which in this case is in form of a ball and socket joint holder so as to be capable of swiveling. The present embodiment of the invention serves as a brake light that may be installed at the rear and on top of a truck 30 with a box body as shown in FIG. 1. A centered placement of the brake light housing 10 with the camera 14 is especially advantageous here. For this reason the camera 14, which is integrated in the brake light housing 10, is oriented downward in a standard manner and is also located below the lighting element 12 of the light. In this manner the area directly behind the truck 30 can be monitored completely with a suitable focal distance without letting the light of the lighting element 12 affect the image quality obtained by the camera 14. Reference number 18 indicates a convexly shaped cover of the camera causing the lime scum and dirt residues to be deposited merely in form of a small spot around the center of the cover so that the image quality is affected only to a negligible degree.

The image quality of the image obtained by the camera can be affected by the lighting element lighting up. If however the camera is moved forward relative to the light source of the lighting element, it is not possible for the light rays of the lighting element to reach the camera and thus to affect the obtained image adversely. This also applies if the main direction of the light rays of the lighting element is different from the orientation of the camera, such as an angle greater than 0° is formed between the main direction of light rays and the orientation of the camera. In this case too, the placement of the camera can prevent light rays of the lighting element from reaching the camera.

A light shield 20 is advantageously provided in order to shield the camera from incident light of the lighting element, and reduce any light interference with the cameral operation. The light shield can in that case be provided on the lighting element and/or around the camera.

Camera 14 preferably is capable of swiveling and/or shifting around at least one axis, making it possible to observe different areas outside the vehicle in following the driver's wishes. Such a moveable camera may replace a plurality of fixed cameras.

In another aspect of the invention camera 14 is mounted in such manner that it can be adjusted with at least two degrees of freedom. More precisely, the camera is mounted by means of a ball and socket joint holder so as to be pivoting, so that the camera is mounted with at least two degrees of freedom. Thus, a larger area can be viewed by the camera according to the sixth aspect than with a camera that can swivel only around one axis.

Referring now to FIG. 3, the embodiment of the invention is shown wherein the camera and light have a convex cover 18. The cover is located in front of the camera lens and is preferably convex so that the center of the convex cover is located over the center of the camera lens. This design is advantageous because a liquid such as raindrops remains for the longest time around the center of the convex, flat cover before the liquid falls in form of drops from the cover as a result of gravity. Because of the convex form, the liquid leaves lime scum and dirt residues merely around the center of the convex cover, which is the lowest point in the case of a camera pointed downwards. The lime scum and dirt residue merely produce a small spot having only negligible influence, in particular when cameras with short focal lengths are used. The intervals between cleanings of the cover can thus be lengthened considerably. The embodiment shown in FIG. 3 differs from FIG. 2 in that the housing cover 22 of FIG. 3 covers camera 14 fully, thus protecting camera from the elements. Housing cover 72 from FIG. 1 does not enclose camera 14. Thus, convex lens 68 provides the protection as described above.

In addition, according to another aspect of the invention, the housing itself can be a cover or have a cover that is convex in at least one area, in which the camera records through the housing. This means that the housing may have a cover that is completely convex, but may also have a convex vaulting in only a portion of the cover. With a cover oriented downwards, or with the area of the cover oriented downwards, the same advantages are thereby achieved as with the cover directly on the camera as described earlier. In addition this embodiment is advantageous because the specially shaped cover on the camera can be omitted. In addition, the camera can be integrated completely within the housing and the advantageous characteristics of a convexly shaped cover can nevertheless be achieved.

The orientation of the camera can also be changed during operation by means of actuators (not shown). In addition, manual adjustability is also advantageous in order to place the camera into a starting position suitable for operation.

Referring now to FIG. 5, another embodiment of the invention is shown. Camera 14 is now embodied in the center of a plurality of lighting elements 24a-24h. These lighting elements are not the traditional halogen or fluorescent lights. Rather lighting elements 24a-24h are LED lights. As such, the camera is forward of these lighting elements and the lighting elements do not affect the quality of the images obtained by camera 14.

The placement of the camera in the center of a lighting field consisting of several lighting elements allows for the greatest possible freedom in designing the light. This design is especially advantageous if the lighting element is an LED or lighting diode instead of the halogen, xenon or incandescent light normally used in vehicle construction.

As has been discussed above, the system includes an integrated camera in the housings of lights within a vehicle, such that a manufacturer need not deal with an additional component that must be integrated into the body of the vehicle. Instead, this system keeps the currently used design and construction processes, requiring merely an additional connection on the inside of any camera-equipped light, as well as a corresponding cable connection inside the vehicle. Furthermore, the camera need not be separately considered in planning the aerodynamic characteristics of a vehicle. Further, the camera is better protected from damage than if it were located on rather exposed locations on the body.

As shown above in a preferred embodiment of the present invention the camera is installed below or next to the lighting element. This design is advantageous if the light is used as a docking or loading aide for trucks, mobile homes etc. On these vehicles it is best to install the camera in the highest position possible in order to cover the widest possible area with the camera. It is advantageous if both the light and the camera are installed near the top, and in particular, in the center of a box shaped body of a truck. Since the camera is located below the lighting element and is mounted pointed downwards when used as a docking or loading aide for trucks, the obtained image quality is not affected by the activated lighting element. In addition the utilization of the invention according to this embodiment is advantageous by serving as the third brake light required by law in several countries. In that case it is advantageous that the lighting element, such as the flat lighting element in reverse lights, not be interrupted by the camera so that a closed lighting surface is presented to the outside and the incorporated camera is not noticed by the observer when the brake light lights up.

A further advantage of the above disclosed invention can also be achieved if the camera is placed in such manner relative to the lighting element that no light of the lighting element shines into the camera.

While a preferred embodiment of the invention has been described using specific terms, such description is for illustrative purposes only, and it is to be understood that changes and variations may be made without departing from the spirit or scope of the following claims.

1. A system for providing the driver of a vehicle with images of the area behind the vehicle, and providing lighting from the back of a vehicle indicating operations of the vehicle comprising:
a vehicle light housing for installation on the rear of a vehicle;
a lighting element for providing lighting from the back of a vehicle to indicate actions of the vehicle such as braking or placing the vehicle in reverse embodied within said vehicle light housing;
a camera for providing images of the area behind the vehicle to a user of the vehicle embodied within said vehicle light housing in a manner and position that is protected from light emitted by said lighting element;
power connectors embodied on the rear portion of said vehicle light housing for connecting said vehicle light housing to a power source for providing power to said lighting element and said camera;
a video connector member embodied on the rear of said vehicle light housing for transmitting the images obtained by said camera to the operator of the vehicle; and
a housing cover for protecting said lighting element protruding from the rear of said vehicle light housing and covering said lighting element.

2. The system of claim 1, wherein said camera is vertically spaced below said lighting element in order to allow said camera to obtain images that are not affected by the actuation of said lighting element.

3. The system of claim 1, wherein said camera is horizontally spaced from said lighting element such that said camera can obtain images without interference from the actuation of said lighting element.

4. The system of claim 1, further comprising a shield for preventing light from said lighting element from affecting the camera, whereby said camera can provide images of the area behind the vehicle without light interference from said lighting element.

5. The system of claim 4, wherein said shield is carried by said housing and is disposed between said lighting element and said camera.

6. The system of claim 4, wherein said housing cover encloses said lighting element and said camera.

7. The system of claim 6, wherein said cover is clear in an area through which said camera records for effective camera recording.

8. The system of claim 7, wherein said housing cover is a generally clear cover and said lighting element emits a red light.

9. The system of claim 1, wherein said camera is capable of swiveling, whereby images of the area behind the vehicle are provided to a user of the vehicle with a wider range.

10. The system of claim 9, wherein said camera is mounted by means of a ball and socket joint, wherein said camera is capable of swiveling whereby images of the area behind the vehicle are provided to a user of the vehicle with a wider range.

11. The system of claim 1, further comprising a convexly shaped lens on said camera for protecting image distortion due to any environmental elements collecting on said camera.

12. The system of claim 1, wherein said housing cover is convex in at least the area in which the camera records through said housing cover whereby said camera obtains images unaffected by any accumulated environmental elements.

13. The system of claim 1, further comprising a plurality of lighting elements.

14. The system of claim 9, wherein said camera is surrounded by said lighting elements.

15. The system of claim 13, wherein said lighting elements are LED's.

16. A vehicle light housing for installation on the rear of a vehicle for providing lighting from the back of the vehicle and providing images to a user of the vehicle of the area behind the vehicle comprising:
a lighting element for providing lighting from the back of a vehicle to indicate actions of the vehicle such as braking or placing the vehicle in reverse;
a camera for providing images of the area behind the vehicle to a user of the vehicle; and
a housing cover for protecting said lighting element and said camera by covering them whereby said camera and said light are protected from external environmental elements.

17. The vehicle light housing of claim 16, wherein said camera is vertically spaced below said lighting element, whereby no light from said lighting element enters said camera.

18. The vehicle lighting housing of claim 16, wherein said camera is horizontally spaced from said lighting element, whereby no light from said lighting element enters said camera.

19. The vehicle light housing of claim 16 further comprising a plurality of lighting elements.

20. The vehicle light housing of claim 19, wherein said camera is surrounded by said lighting element.

21. The vehicle light housing of claim 19, wherein said multiple lighting element is a plurality of LED's.

22. The vehicle light housing of claim 16, further comprising a light shield for preventing the light of said lighting element from entering the camera, whereby no light from said lighting element enters said camera.

23. The vehicle light housing of claim 16, wherein said camera is mounted by means of a ball and socket joint, wherein said camera is capable of swiveling, whereby a wide range of images can be captured by said camera and provided to the user of the vehicle.

24. The vehicle light housing of claim 16, further comprising a convexly shaped lens for said camera, whereby environmental elements do not affect the images obtained by said camera.

25. The vehicle light housing of claim 16, wherein said housing cover encloses said lighting element and said camera.

26. The vehicle light housing of claim 25, wherein said housing cover is convex at least in one area in which the camera records through said housing cover, whereby environmental elements do not affect the images obtained by said camera.

27. The vehicle light housing of claim 16, wherein said housing cover is clear in an area through which the camera records for effective camera recording.

28. The vehicle light housing of claim 16, wherein said housing cover is generally clear and said lighting element emits a red light.
